(19) United States
(12) Patent Application Publication
(10) Pub. No.: US 2026/0206718 A1
(43) Pub. Date: Jul. 23, 2026

(54) CAT LITTER BOX WITH TRASH CAN

(71) Applicant: Zhongshan Xiaohan Intelligent Technology Co., Ltd., Zhongshan (CN)

(72) Inventor: Jun CHEN, Mianyang (CN)

(21) Appl. No.: 19/026,738

(22) Filed: Jan. 17, 2025

(51) Int. Cl. A01K 1/01

(52) U.S. Cl. CPC A01K 1/011

(57) ABSTRACT

The invention provides a cat litter box with a trash can, which comprises a shell, wherein the shell comprises a bottom shell, a middle shell and a top shell which are removably fixed in sequence from bottom to top. The cat litter box of the invention has large inner space, and the user can decide whether the bottom shell is combined with the trash can, or the bottom shell is combined with the middle shell and the trash can, or the bottom shell, the middle shell and the top shell are combined with the trash can, and combine different parts according to the user’s habits, thereby being more flexible during use; meanwhile, the trash can is not easily overturned when a pet cat uses and comes out of the litter box,; in addition, the structure of the top shell ensures that cat hair does not fly around.

### TECHNICAL FIELD

The invention relates to the field of pet products, in particular to a cat litter box with a trash can.

### BACKGROUND ART

As a pet cat toiletry, cat litter box is an appliance facilitating to clean up pet excreta. Therefore, for people who like to keep pets, the cat litter box is essential.

The traditional cat litter box has a simple structure. Basically, a layer of cat litter is spread in the litter box, the pet cat paws litter to cover up urine and feces after defecating, and the user needs to clean the litter box regularly.

### SUMMARY OF THE INVENTION

The invention aims to provide a cat litter box with a trash can, which is not easily overturned when a pet cat uses and comes out of the litter box, thereby being convenient to clean; at the same time, the user can use the cat litter box in a variety of combinations according to preferences and habits.

A cat litter box with a trash can comprises a shell with an entrance part for a pet to enter, wherein the shell comprises a bottom shell, a middle shell and a top shell which are removably fixed in sequence from bottom to top, a containing space for placing cat litter is formed in the bottom shell, a trash can is arranged at an opening part of the bottom shell and arranged inside the bottom shell or connected outside the bottom shell and close to the opening part, the top shell is provided with a cavity part with an opening, a first strip hole is arranged at the bottom of the cavity part, and a removable top cover is arranged at the opening of the cavity part.

By adopting the above technical proposal, the cat litter box has large inner space, and the user can decide whether the bottom shell is combined with the trash can, or the bottom shell is combined with the middle shell and the trash can, or the bottom shell, the middle shell and the top shell are combined with the trash can, and combine different parts according to the user’s habits, thereby being more flexible during use; meanwhile, the trash can is not easily overturned when a pet cat uses and comes out of the litter box, thereby being convenient to clean; in addition, the structure of the top shell ensures that cat hair does not fly around, thereby enhancing the convenience of cleaning.

Preferably, the entrance part is an ascending wedge-shaped opening gradually becoming larger from the bottom shell to the top shell opening, and is connected with an auxiliary cover plate, an auxiliary entrance is arranged at the entrance part corresponding to the auxiliary cover plate, and the auxiliary entrance corresponding to the auxiliary cover plate is connected with a door plate part capable of closing or opening the auxiliary entrance.

Preferably, the door plate part is hinged with the auxiliary cover plate, and the auxiliary cover plate is hinged with the top shell.

By adopting the above structure, the shell can be used in a variety of forms, and it is very convenient to use.

Preferably, when the trash can is arranged in the containing space of the bottom shell, the trash can is provided with a fixed step on one side near the bottom shell, an edge part turning outward away from the side of the trash can is arranged at the top of the bottom shell, an open slot is arranged on one side of the middle shell facing toward the bottom shell, one side wall is arranged on the fixed step, the edge part is arranged in the open slot of the middle shell, an auxiliary fixing structure is arranged between the trash can and the bottom shell and comprises a fixing part fixed between the top and the edge part of the trash can and a tilting part inclined downward from the fixing part towards the bottom of the bottom shell.

Preferably, a trash cover plate is arranged at the top of the trash can, and cover plate through holes for the cat litter to fall are arranged on the trash cover plate.

By adopting the above structure, the trash can is firmly fixed in the bottom shell; it is also very easy to take out the trash can to clean the trash; at the same time, the trash cover plate can also ensure that the carried cat litter or hair can drop into the trash can when the pet cat jumps out of the litter box.

Preferably, when the trash can is connected to the outside of the bottom shell, a mounting step is arranged on one side of the trash can facing toward the bottom shell, a positioning groove is formed between the mounting step and the bottom shell, an outer edge turning outward is formed on the bottom shell toward the mounting step and is arranged above the mounting step, and the middle shell is abutted with the outer edge and is provided with a middle shell flange embedded in the positioning groove.

Preferably, a second fixing structure is arranged between the bottom shell and the middle shell and comprises a second fixing part fastened on the middle shell flange and a second tilting part inclined downward from the second fixing part towards the bottom of the bottom shell.

Preferably, the trash cover plate is arranged at the top of the trash can, the cover plate through holes for the cat litter to fall are arranged on the trash cover plate, and a locking structure capable of locking the trash cover plate and the trash can is arranged between the two.

By adopting the above technical proposal, the trash can can form a solid connection with the shell and is not easily overturned when being fixed on the outside of the bottom shell; it is also very easy to take out the trash can to clean the trash; at the same time, the trash cover plate can also ensure that the carried cat litter or hair can drop into the trash can when the pet cat jumps out of the litter box.

### BRIEF DESCRIPTION OF THE DRAWINGS

FIG. 1 is the schematic diagram of the embodiment 1 for a cat litter box structure with a trash can in the invention.

FIG. 2 is the explosive view of the embodiment 2 for a cat litter box structure with a trash can in the invention.

FIG. 3 is the section view of the embodiment 1 for a cat litter box structure with a trash can in the invention.

FIG. 4 is the enlarged view of Part A in FIG. 3.

FIG. 5 is the schematic diagram of the embodiment 2 for a cat litter box structure with a trash can in the invention.

FIG. 6 is the explosive view of the embodiment 2 for a cat litter box structure with a trash can in the invention.

FIG. 7 is the section view of the embodiment 2 for a cat litter box structure with a trash can in the invention.

FIG. 8 is the enlarged view of Part B in FIG. 7.

Reference signs: 1. Shell; 11. Bottom shell; 110. Containing space; 111. Edge part; 112. Outer edge; 12. Middle shell; 121. Middle shell flange; 122. Open slot; 13. Top shell; 130. Cavity part; 1301. First strip hole; 131. Top cover; 1310. Second strip hole; 14. Entrance part; 15. Auxiliary cover plate; 150. Auxiliary entrance; 16. Door plate part; 2. Trash can; 21. Trash cover plate; 210. Cover plate through hole; 22. Mounting step; 23. Positioning groove; 24. Fixing step; 3. Auxiliary fixing structure; 31. Fixing part; 32. Tilting part; 4. Second fixing structure; 41. Second fixing part; 42. Second tilting part; 5. Locking structure.

### DETAILED DESCRIPTION OF THE INVENTION

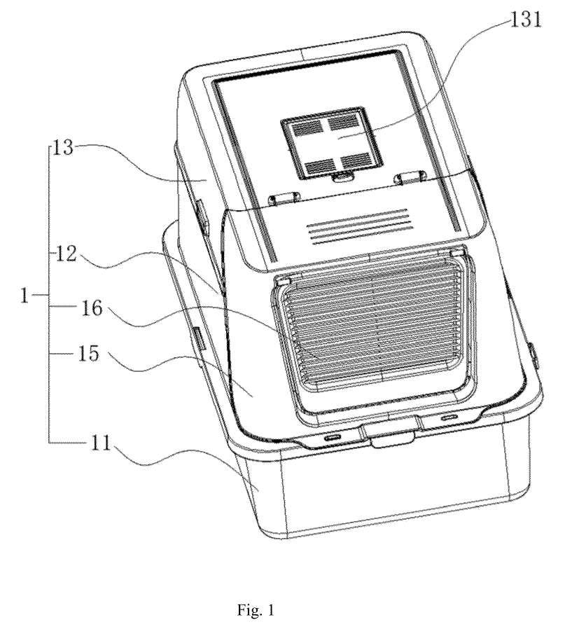

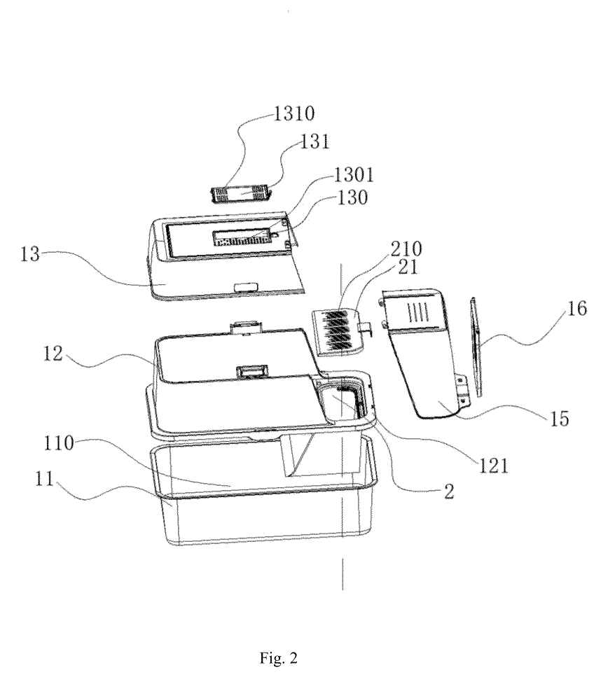

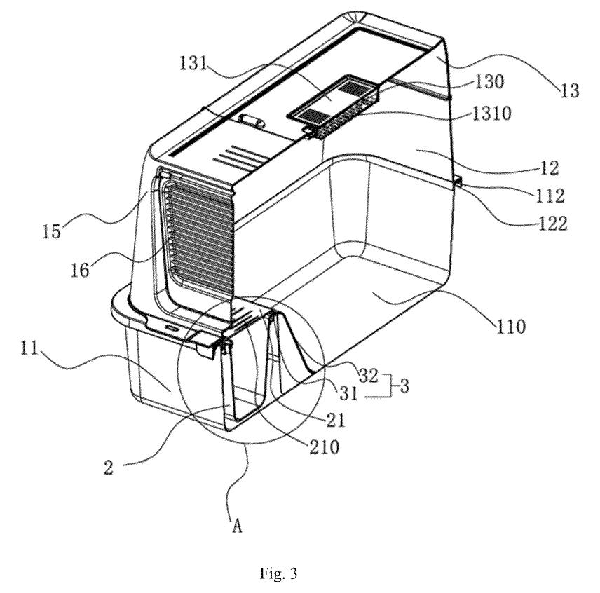

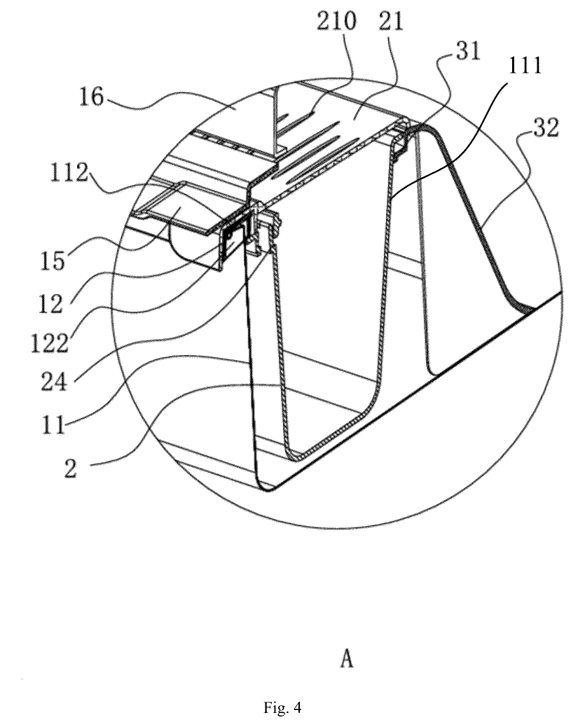

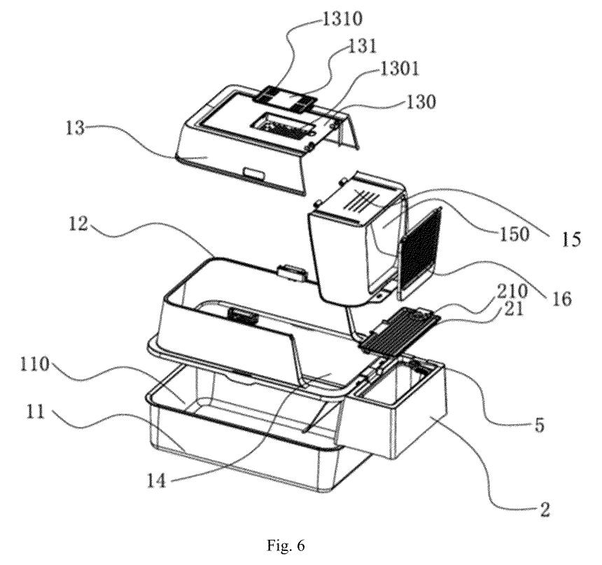

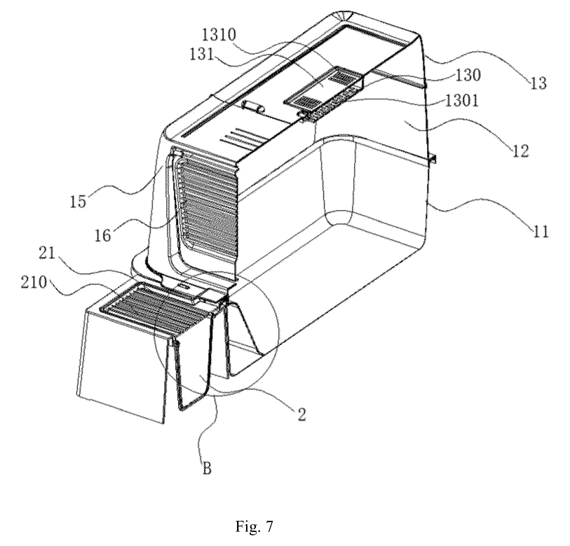

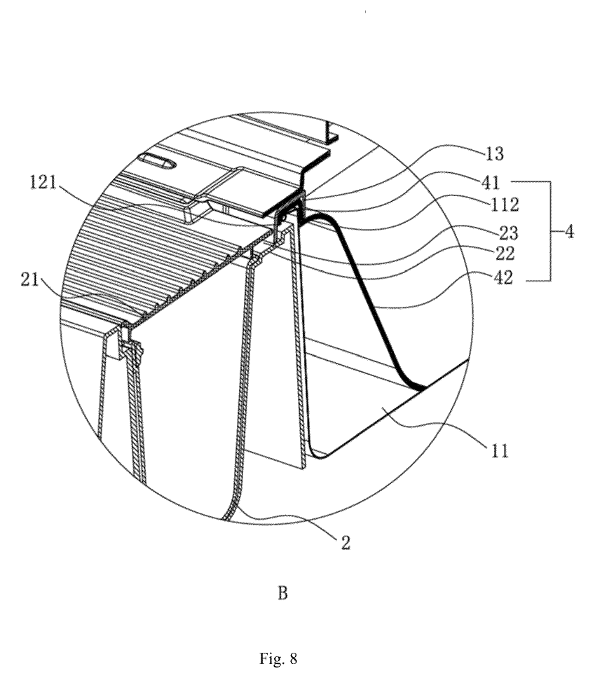

The invention is further described below in combination with FIG. 1 to FIG. 8.

### Embodiment 1

As shown in FIG. 1 to FIG. 4, a cat litter box with a trash can 2 comprises a shell 1, wherein the shell 1 comprises a bottom shell 11, a middle shell 121 and a top shell 131 which are removably fixed in sequence from bottom to top, a containing space 110 for placing cat litter is formed in the bottom shell 11, the top of the bottom shell 11 is completely open, the middle shell 121 is a frame structure, a fully open opening is arranged on one side of the top shell 131 facing toward the bottom shell 11, a top wall is arranged on the top of the top shell 131, the top shell 131 is provided with a cavity part 130 with an opening, a first strip hole 1301 is arranged at the bottom of the cavity part 130, a removable top cover 131 is arranged at the opening of the cavity part 130, a second strip hole 1310 is arranged on the top cover 131, the projections of the first strip hole 1301 and the second strip hole 1310 do not coincide at the bottom and are not parallel (the projections of the first strip hole 1301 and the second strip hole 1310 can also coincide or be parallel, but this may cause cat hair to fly out of the top cover 131, so it is preferable that the projections of the two do not coincide and are not parallel).

An entrance part 14 for a pet to enter is formed among the bottom shell 11, the middle shell 121 and the top shell 131, the entrance part 14 is an ascending wedge-shaped opening gradually becoming larger from the bottom shell 11 to the top shell opening, and is connected with an auxiliary cover plate 151, an auxiliary entrance 150 is arranged at the entrance part 14 corresponding to the auxiliary cover plate 151, and the auxiliary entrance 150 corresponding to the auxiliary cover plate 151 is connected with a door plate part 16 capable of closing or opening the auxiliary entrance 150.

The door plate part 16 is hinged with the auxiliary cover plate 151, and the auxiliary cover plate 151 is hinged with the top shell 131 (it should be noted here that the door plate part 16 and the auxiliary cover plate 151 can also be connected through a buckle, and the auxiliary cover plate 151 and the top shell 131 can also be connected through a buckle in order to facilitate disassembly).

The bottom shell 11 is provided with a trash can 2 at the opening, the trash can 2 is arranged inside the bottom shell 11, the trash can 2 is provided with a fixed step 24 on one side near the bottom shell 11, an edge part 112 turning outward away from the side of the trash can 2 is arranged at the top of the bottom shell 11, an open slot 122 is arranged on one side of the middle shell 12 facing toward the bottom shell 11, one side wall is arranged on the fixed step 24, the edge part 12 is arranged in the open slot 122 of the middle shell 12, an auxiliary fixing structure 3 is arranged between the trash can 2 and the bottom shell 11 and comprises a fixing part 31 fixed between the top and the edge part 111 of the trash can 2 and a tilting part 32 inclined downward from the fixing part 31 towards the bottom of the bottom shell 11 (it should be noted here that the auxiliary fixing structure 3 is preferably monolithic).

A trash cover plate 21 is arranged at the top of the trash can 2, and cover plate through holes 210 for the cat litter to fall are arranged on the trash cover plate 21.

By adopting the above structure, the trash can 2 is firmly fixed in the bottom shell 11; it is also very easy to take out the trash can 2 to clean the trash; at the same time, the trash cover plate 21 can also ensure that the carried cat litter or hair can drop into the trash can 2 when the pet cat jumps out of the litter box.

### Embodiment 2

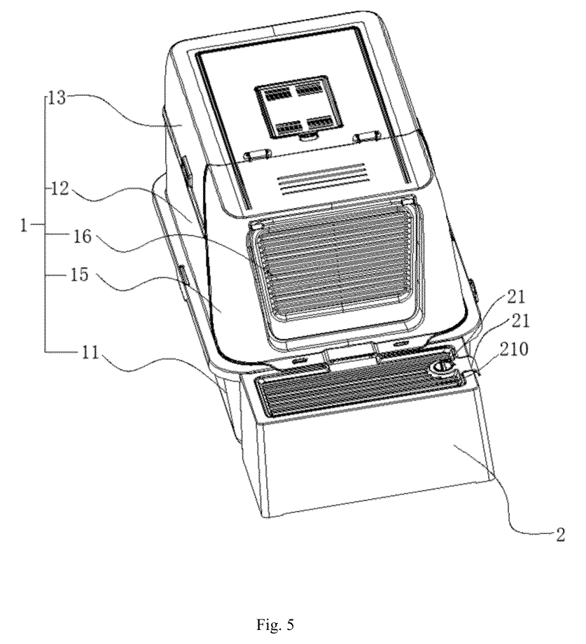

As shown in FIG. 5 to FIG. 8, different from the embodiment 1, the trash can 2 is connected to the outside of the bottom shell 11 and is close to the opening part, a mounting step 22 is arranged on one side of the trash can 2 facing toward the bottom shell 11, a positioning groove 23 is formed between the mounting step 22 and the bottom shell 11, an outer edge 112 turning outward is formed on the bottom shell 11 toward the mounting step and is arranged above the mounting step 22, and the middle shell 121 is abutted with the outer edge and is provided with a middle shell flange 121 embedded in the positioning groove 23.

A second fixing structure 4 is arranged between the bottom shell 11 and the middle shell 121 and comprises a second fixing part 41 fastened on the middle shell flange 121 and a second tilting part 42 inclined downward from the second fixing part 41 towards the bottom of the bottom shell 11.

A trash cover plate 21 is arranged at the top of the trash can 2, cover plate through holes 210 for the cat litter to fall are arranged on the trash cover plate 21, and a locking structure capable of locking the trash cover plate 21 and the trash can 2 is arranged between the two (it should be noted here that the locking structure can be an existing structure, for example, a groove and a convex part are arranged between the two and are fastened or separated from each other by rotating to achieve mutual locking or unlocking, or the two are fixed or separated through a bolt and a nut, which is not detailed here as it is not the core innovation point of the invention and is realized in various forms).

When being fixed on the outside of the bottom shell 11, the trash can 2 can form a solid connection with the shell 1 and is not easily overturned; it is also very easy to take out the trash can 2 to clean the trash; at the same time, the trash cover plate 21 can also ensure that the carried cat litter or hair can drop into the trash can 2 when the pet cat jumps out of the litter box.

The above embodiments are only the preferred embodiments of the invention, but not intended to limit the scope of protection of the invention. Any immaterial changes and substitutions made by technicians in the field on the basis of the invention fall within the scope of protection required by the invention.

What is claimed is:

1. A cat litter box with a trash can, comprising:
a shell,defining an entrance part for a pet to enter, wherein the shell comprises following elements that are fixed in sequence from bottom to top and are removable from each other:
a bottom shell, defining a containing space for placing cat litter and an opening part,
a middle shell, and
atop shell, comprises:
a cavity part that defines an opening and a plurality of first strip holes arranged at a bottom thereof: and a removable top cover, arranged at the opening of the cavity part; and
he trash can,located adjacent to the opening partsand arranged inside the bottom shell or connected outside the bottom shell and adjacent to the opening par.

2. The cat litter box with the trash can according to claim 1, characterized in that the entrance part is an ascending wedge-shaped opening gradually becoming larger from the bottom shell to the top shell opening, and the shell further comprises:
an auxiliary cover plate, connected to the top shell and covering the entrance part, and defining an auxiliary entrance corresponding to the entrance part: and -a door plate part, connected to the auxiliary cover plate and capable of closing or opening the auxiliary entrance.

3. The cat litter box with the trash can according to claim 2, characterized in that the door plate part is hinged with the auxiliary cover plate, and the auxiliary cover plate is hinged with the top shell.

4. The cat litter box with the trash can according to claim 1, characterized in that when the trash can is arranged in the containing space of the bottom shell, the trash can is provided with a fixed step on one side near the bottom shell, an edge part turning outward away
from the side of the trash can is arranged at the top of the bottom shell, an open slot is arranged on one side of the middle shell facing toward the bottom shell, one side wall is arranged on the fixed step, the edge part is arranged in the open slot of the middle shell, an auxiliary fixing structure is arranged between the trash can and the bottom shell and comprises a fixing part fixed between the top and the edge part of the trash can and a tilting part inclined downward from the fixing part towards the bottom of the bottom shell.

5. The cat litter box with the trash can according to claim 4, characterized in that a trash cover plate is arranged at the top of the trash can, and cover plate through holes for the cat litter to fall are arranged on the trash cover plate.

6. The cat litter box with the trash can according to claim 1, characterized in that when the trash can is connected to the outside of the bottom shell, a mounting step is arranged on one side of the trash can facing toward the bottom shell, a positioning groove is formed between the mounting step and the bottom shell, an outer edge turning outward is formed on the bottom shell toward the mounting step and is arranged above the mounting step, and the middle shell is abutted with the outer edge and is provided with a middle shell flange embedded in the positioning groove.

7. The cat litter box with the trash can according to claim 6, characterized in that a second fixing structure is arranged between the bottom shell and the middle shell and comprises a second fixing part fastened on the middle shell flange and a second tilting part inclined downward from the second fixing part towards the bottom of the bottom shell.

8. The cat litter box with the trash can according to claim 6, characterized in that the trash cover plate is arranged at the top of the trash can, the cover plate through holes for the cat litter to fall are arranged on the trash cover plate, and a locking structure capable of locking the trash cover plate and the trash can is arranged between the two.
